(19) United States
(12) Patent Application Publication
(10) Pub. No.: US 2020/0217546 A1
(43) Pub. Date: Jul. 9, 2020

(54) System and Method for Pressure Monitoring and Stabilization in HVAC Systems

(71) Applicants: Tim Seaton, Pittsboro, NC (US); Tommi Parkkila, Cary, NC (US)

(72) Inventors: Tim Seaton, Pittsboro, NC (US); Tommi Parkkila, Cary, NC (US)

(21) Appl. No.: 16/239,249

(22) Filed: Jan. 3, 2019

(51) Int. Cl. F24F 11/49; F24F 11/58; F24F 11/64; F24F 11/65; G05B 19/042

(52) U.S. Cl. CPC F24F 11/49; F24F 11/58; F24F 2110/10; F24F 11/65; G05B 19/042; F24F 11/64

(57) ABSTRACT

A pressure stabilization system for an HVAC device. The pressure stabilization system consists of a monitoring unit attached to the refrigerant and pressure lines of an exterior mounted or connected HVAC unit. Multiple sensors will measure refrigerant levels, unit vibration, ambient temperature, and humidity and provide the collected sensor measurements to a cloud-based platform. The cloud-based platform will provide operational command and control to permit a user to control the unit, add refrigerant, add sealant, and receive recommendations for HVAC operation and maintenance.

### CLAIM OF PRIORITY

This Non-Provisional application claims under 35 U.S.C. § 120, the benefit of the Provisional Application 62/613,086, filed Jan. 3, 2018, Titled “System and Method for Pressure Stabilization in Residential HVAC Systems”, which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Heating, ventilation, and air conditioning (HVAC) are systems that are used in both commercial and residential buildings intended to control and monitor the environmental comfort levels within the building. An air filter is one of the most important components of the system, cleaning the air that passes through the filter material. HVAC manufacturers calculated system performance based on ideal air flow with a reference filter. When different filters are used by the homeowner, and/or as filters capture particulate from the air stream, the optimum system performance is compromised. This reduced efficiency places stress on HVAC system components and increases the amount of energy required to heat or cool the home. Typically monitoring systems for residential and commercial HVAC purposes do not measure air filter condition and depend upon a user to replace the air filter on a regular basis. More recent developments provide for limited monitoring of air filter condition. Additionally, the conventional use of HVAC monitoring systems has begun to allow for a signaling response to an internal unit within the home or a singular remote device worn by the user when the replacement time period has been exceeded.

Manufacturers have attempted to develop devices to proactively monitor the pressure difference for a single medium such as pressure or temperature. This has been a means of determining when a filter would need to be changed. In addition to monitoring HVAC conditions, the extent of previous devices have used such accessories as wearable wrist bands which operate in conjunction with a Bluetooth port or other wireless communication. Conventional devices have succeeded at determining when to change a filter under designated conditions such as specifically when pressure readings reach a certain threshold value.

### BRIEF DESCRIPTION OF THE DRAWINGS

Certain illustrative embodiments exemplifying the organization and method of operation, together with objects and advantages, may be best understood by reference to the detailed description that follows, taken in conjunction with the accompanying drawings in which:

FIG. 1 is a system diagram of an embodiment of the HVAC monitoring system consistent with certain embodiments of the present invention.

FIG. 2 is a block diagram of an exemplary apparatus for monitoring an HVAC pressure monitoring system consistent with certain embodiments of the present invention.

FIG. 3 is a flow diagram of an exemplary method of monitoring an HVAC pressure monitoring system consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “mobile device” refers to any handheld device such as, but not limited to, a smart phone, tablet, iPad, network computer, watch or any other device a user may employ to interact with one or more networks.

Reference throughout this document to HVAC refers to a Heating, Ventilating, and Air Conditioning system installed in residential or commercial properties.

In an embodiment, the proposed invention as outlined allows for more efficient and greater scope in monitoring and HVAC pressure stabilization by using a wide range of measuring components which allows for increased monitoring capability over various systems and environmental conditions not limited to HVAC. This increased monitoring system capability includes commercial and residential systems which encompasses additional systems besides the traditional HVAC monitoring and provides for the ability to stabilize pressure in a monitored system when configured in the pressure stabilization mode. The proposed inventive idea interfaces with a plurality of software services, such as cloud-based services and other software-as-a-service systems, while utilizing technology available on mobile devices, such as iOS and Android devices, in a way which has not been provided previously. Using a broader array of sensors to detect various conditions that indicate both operational and system health provides an advantage to the proposed invention.

In an embodiment, the Pressure Monitoring and Stabilization apparatus for residential and commercial system HVAC system monitoring may have system or application specific measurement elements, one or more elements that provide wireless communication with outside connections and interaction with a user through visual displays. The system may be controlled by a primary processor containing the operational software for command and control of the residential and commercial monitoring system. The monitoring system provides a platform to enter all building related maintenance events, whether commercial or residential, and provides the ability to collect and analyze measurement information to assist in HVAC maintenance. Additional system connectivity and operational conditions for equipment and/or devices that are not directly connected to the monitoring system may also be detected based upon acoustic and other measurement data collected by sensors. The acoustic and other measurement data permit data collection about ambient conditions in the environment in which the system sensors are installed. This information may include information about the condition of the hardware components, operation of the device or apparatus being monitored, and information about system components that may be inferred from data collected about ambient conditions during operation of the HVAC equipment.

The Pressure Monitoring and Stabilizer system is a product consisting of two units;

1. A Battery powered Multi-Sensor Device, and

2. A Refrigerant Stabilizer device.

The Multi-Sensor Device is a battery powered device, which is mounted on the input and output refrigerant pipes of an outdoor air condenser unit and monitors the condition of an HVAC system in real-time, or on demand by a user. The Multi-Sensor system measures the condition of an air conditioner unit of central heating and cooling air ventilation system, as well as a split unit or ductless air conditioner and/or heat pump system, each of which are defined as an Air Conditioner system (AC-system). The condition of the AC-system is determined from, but not limited to, the following nondestructive measurements:
Temperature measurements of both refrigerant lines/pipes to and from the AC-system,
Ultra-sound measurements,
Impedance
Vibration measurements, and
AC-system ON/OFF duty cycle.

The Multi-Sensor Device collects the measurements, compresses the measurements and sends the measurements to a cloud-based information and data storage system, Breezi-Cloud, via a low power cellular connection, or by other wireless protocols to a networked device. In the Breezi-cloud information and data storage system or within the primary processor of the monitoring system, an AC-system Condition Algorithm detects AC-system condition anomalies from the measured and captured data transmitted to the analysis element of the system. Detectable anomalies or failure modes of AC-system defined within the monitoring system may consist of, but are not limited to:
Refrigerant leaks,
Efficiency drop, and
Mechanical irregularities.

The failure modes are reported to a corresponding previously identified service provider, property manager or an owner of the AC-system or any other defined user. The Multi-Sensor Device can be used with or without the Refrigerant Stabilizer device.

A Refrigerant Stabilizer device is an apparatus that may be connected to refrigerant valves of the air condenser unit of an outdoor AC-system. As commanded by Multi-Sensor Device via wireless or wired connection, Refrigerant Stabilizer can:
Add leak sealant material to the refrigerant system, and
Add refrigerant compound to the refrigerant system.

Refrigerant Stabilizer requires Multi-Sensor device to be installed on the same air condenser unit upon which the Refrigerant Stabilizer is installed.

The Multi Sensor Device is composed of the following elements:

### Micro-Controller Unit

The Micro-Controller Unit is the main computing unit of the Multi Sensor Device. It is responsible for:

Interfacing and Conducting Liquid Line Sensor and Suction Line Sensor unit measurements, communication with the Breezi-Cloud information and data storage system, hereinafter called “Breezi-Cloud”, via the wireless communication unit, transmitting measurement data and receiving commands and configuration data for measurements, communication with a human/machine interface device, for example, utilizing a mobile phone to communicate system status and health information to user directly, and managing the power supply from battery or 12/24 VDC line power.

If the Refrigerant Stabilizer device is connected to the HVAC system and the Pressure Monitoring and Stabilization system, the micro-controller unit will interface with and conduct gas pressure measurements of the suction line, and interface with and control the controllable valve system of Refrigerant Stabilizer device to bleed air out from the AC system, inject system sealant from sealant tank, and/or recharge refrigerant from Refrigerant Tank.

### Wireless Communication Unit

This unit provides direct data communication from device to Breezi-cloud. The Wireless Communication unit also establishes and manages the data communication with one or more personal area networks utilizing near-field communication standards such as, in a non-limiting example, Bluetooth Low Energy (BLE), for direct human to machine interaction.

### Ambient Temperature and Humidity Sensors

This unit measures ambient outdoor temperature and humidity. This data measurements collected by this subsystem may be utilized to calculate the cooling efficiency of the condenser unit,

### Liquid Line Sensor Unit

The liquid line sensor unit is mounted on the side of the HVAC system identified as the high-side or, if the high-side is not clearly delineated, the liquid line copper, pipe installed with many HVAC units with an easy clamp-on mechanism near the access port of the condenser unit. The sensor units consist of the following sensors;

A temperature sensor, which may, in a non-limiting example, be a thermocouple, which is operational to measure surface and radiated temperature of the liquid refrigerant inside the pipeline to which the liquid line sensor unit is attached, and a

Vibration sensor, which may, in a non-limiting example, be implemented as an accelerometer.

The sensors are active to measure mechanical vibration of the condenser unit of the MAC or other system to capture data to determine the condenser ON/OFF status. Additionally, mechanical vibration may be indicative of mechanical anomalies of the condenser unit, which the sensor measurements may capture as well. An impedance sensor may be attached to the system to measure refrigerant flow and level in the liquid line pipeline. Additionally, an ultrasound sensor may be attached to the system being measure to capture refrigerant flow and refrigerant level measurements in the pipeline.

### Suction Line Sensor Unit

The suction line sensor unit may be mounted on the portion of the HVAC or other system being measured as the low-side or suction line copper pipe with an easy clamp-on mechanism near the access port of condenser unit. The suction line sensor unit may consist of the following sensors;

One or more temperature sensors, which may, in a non-limiting example, be a thermocouple, to measure surface and radiated temperature of the refrigerant vapor inside the pipeline. A vibration sensor, which may, in a non-limiting example, be an accelerometer, to measure mechanical vibration of condenser unit to capture data to determine the condenser ON/OFF status and mechanical anomalies of the condenser unit. An impedance sensor may be attached to the system being monitored to measure refrigerant flow and level in the pipeline. Additionally, an ultrasound sensor may be attached and configured to measure refrigerant flow and refrigerant level in the pipeline.

### Digital Serial Communication Media

A digital serial communication media or data communication bus is provided and configured for the multi sensor device to control a controllable valve system and collect measurement data from a gas pressure sensor on the refrigerant stabilizer device. Together with Power Supply the digital serial communication media and/or data communication bus form the device interface between the Multi. Sensor Device and Refrigerant Stabilizer device.

### Power Supply

The Multi Sensor Device can be powered through battery or 12/24 VDC inline power supply. Each power source is managed and conditioned by the power supply component. The power supply component provides power to both the Multi Sensor Device and Refrigerant Stabilizer device.

### Refrigerant Stabilizer

### Gas Pressure Sensor

The gas pressure sensor is connected to a controllable valve system. The gas pressure sensor measures the pressure of vapor/gas on the access port of the suction line of an AC condenser unit, the gas pressure during refrigerant recharge, and the gas pressure during sealant injection,

### Controllable Valve System.

The controllable valve system is controlled by the Mufti Sensor Device through data packets transferred through the digital serial communication media or data communication bus. The controllable valve system connects to the refrigerant tank, sealant tank and open-air access to the suction line access port. The controllable valve system connectivity depends upon the action required to be performed. In a non-limiting example, if no action is required, the multi sensor device commands the controllable valve system to close all ports. If air bleeding is required, the mufti sensor device commands the controllable valve system to connect open air to the HVAC access port. If refrigerant recharge is required, the multi sensor device commands the controllable valve system to connect to the refrigerant tank, and if sealant injection is required, the multi sensor device commands the controllable valve system to connect to the sealant tank to permit sealant injection into the system until the sensor measurements for the system pressure indicate that the pressure is stable and within pre-configured measurement settings as provided by the manufacturers recommended pressure readings for the type and model of HVAC or other system to which the Pressure Monitoring and Stabilization system has been attached,

### Digital Serial Communication Media

A digital serial communication media or data communication bus is provided and configured for the multi sensor device to control a controllable valve system and collect measurement data from a gas pressure sensor on the refrigerant stabilizer device. Together with Power Supply the digital serial communication media and/or data communication bus form the device interface between the Multi Sensor Device and Refrigerant Stabilizer device.

### Power Supply

The refrigerant stabilizer device may use the power supply from the Multi Sensor Device to power the controllable valve system and gas pressure sensor.

### System Main Features

The Pressure Stabilizer system collects measurements and sends measurement data to Breezi-Cloud, and controls sealant injection and refrigerant charge if requested by the Breezi-Cloud system. The Control request can be generated automatically or as requested by a remote user. The Breezi-Cloud system collects all the measurement data generated by the Pressure Stabilizer device. Data-analysis functions to analyze and provide results from the measurement data reside in the Breezi-Cloud system, which implements interfaces for users to interact with the measured and analyzed data and the results data provided from the data-analysis component of Breezi-Cloud. Breezi-Cloud provides interfaces to HVAC system owners and service providers.

In an embodiment, when installed and active, the system may detect dropped cooling efficiency of condenser unit where dropped cooling efficiency can be calculated from the data of the temperatures of suction and liquid lines, ambient temperature, and condenser unit duty-cycle (ON-OFF) data determined from vibration data. The system may also detect any low refrigerant level in the HVAC system. Low refrigerant levels can be detected and calculated utilizing the dropped system efficiency data, refrigerant flow measurements, and the measured impedance and/or ultrasound data.

In an embodiment, the system may detect mechanical anomalies of air condenser unit. Mechanical anomalies can be derived from vibration data captured on both suction and liquid line sensor units. Detectable mechanical anomalies include, but are not limited to fan mechanical anomalies and compressor mechanical anomalies.

The monitoring system may report sensor measurements, raw data views, formatted data views, analysis of system operation, and indications of anomalous operation, alerts, or any other data from the sensors, analysis module, or reporting module. The data, alerts, and other information, including, where setup by a user, customized data views, may be communicated to a user through a wired or wireless communication channel. The wired signal may be a connection to a computer system between the monitoring system and a laptop, networked or other computer system. The monitoring system may also connect through a wireless network connection to a cloud-based storage capability where measurement and analysis data may be retained and viewed by a user through a web browser on a computer system. In an alternative embodiment, the monitoring system may connect directly to a mobile device and or application through a wireless connection to a wireless server. The monitoring system may connect through a wireless network, network connected browser, or mobile application to a cloud-based storage capability where measurement and analysis data may be retained and viewed by a user through a web browser or through a mobile application installed on a mobile device.

The mobile application may be installed on a mobile phone, iPad, tablet, network computer, or any other handheld device that is configured for use with mobile applications. The monitoring system may have a mobile application that is installed on the mobile device and permit a user to view any of the data, alerts, and analysis information, and also be configured to permit command and control communications from the user to be sent to the monitoring system. Such command and control communications may permit the user to interact with the system to change parameters, collect additional information, start or stop the system, or perform any other user directed operations as directed by the user. The command and control communications may also permit analysis of operational conditions as well as predictions for recommended service to be communicated to a user or a service provider.

In additional exemplary embodiments, the monitoring system may also provide HVAC usage statistics, estimated energy costs based upon the measured usage of the HVAC system, and provide suggestions for different control options to one or more users to optimize the HVAC system usage. The sensor measurements may be used to create a timeline for the usage of the HVAC system to provide the one or more users with a view of energy consumption over time. A user may enter executed maintenance events on the timeline, plan and schedule maintenance projects and place these scheduled projects on the timeline so that the monitoring system may issue notifications as the scheduled projects come due. All of the information from the monitoring system may be communicated with the one or more users through either wired or wireless networked data channels to provide sensor measurements, timeline information, notifications, alerts, or any other data regarding system performance or usage requested from the monitoring system by the user. Additionally, the monitoring system may be configured to provide condition-based advertisements to the one or more users and transmit these advertisements along with any other system or monitoring data to be received by the one or more users.

The system architecture also provides for connection to, and communication with, the refrigerant stabilizer device. The refrigerant stabilizer device is in communication with a controllable valve system through which the refrigerant stabilizer device may control refrigerant input to the HVAC system, or sealant compounds to the HVAC system if required.

In an embodiment, where the system has been installed with a refrigerant stabilizer component, the system may inject sealant into the refrigerant system to improve HVAC system performance. The system monitors the sensor measurements collected from the sensors collecting pressure, temperature, and vibration data. When the analysis of the pressure, temperature, and vibration data indicates that the HVAC, system performance has fallen below a pre-determined operational value, the system is active to determine the cause of the sub-par system performance. If the sub-par system performance is determined to be caused by leaks in the refrigerant and the refrigerant stabilizer component is installed and active, the system may act to correct the system performance. The correction may be applied through action of the refrigerant stabilizer, where the stabilizer injects sealant to the refrigerant system remotely either automatically as needed, or as requested by a user. In addition, the system can recharge the refrigerant system remotely either automatically, or as requested by a user.

In an embodiment, the system may also provide services to users such as, in a non-limiting example, if the system detects anomalies in performance of the HVAC system, the owner may receive alarms from the system on a mobile application display on the user's mobile device. The system may also permit HVAC system service providers to sell condition-based advertisements to a user on the mobile application installed on the user's mobile device. Additionally, HVAC system service providers can have access to a condition based “opportunity map” that is created by the system through an analysis of collected sensor measurements. As anomalies are detected, the anomalies are matched to users registered with each particular HVAC system. A service provider may receive access to the “opportunity map” by paying a fee, or may have a paid subscription to the “opportunity map” by paying a monthly subscription fee. The service provide may then reach out to customers who have problems according to the data provided by the “opportunity map”.

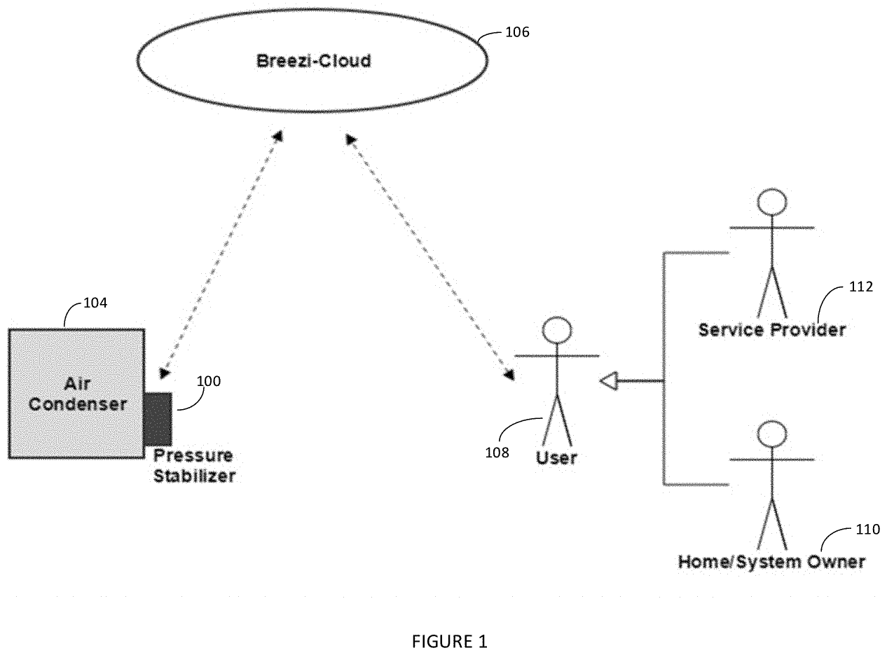

Turning now to FIG. 1, forming part of the disclosure herein, this figure presents a system diagram of an embodiment of the HVAC monitoring system. The Pressure Monitoring and Stabilization (PMS) monitoring system 100 may be attached to the air condenser 104 of an exterior mounted or exterior vented HVAC unit. The PMS is connected through a wireless communication channel to transmit data to a cloud-based storage and operational network platform identified as the Breezi-Cloud platform 106. A user 108 of the PMS system, which may include a home owner 110, HVAC system owner 110, or service provider 112, may connect to the Breezi-Cloud platform 106 to download operational and sensor data, provide commands to the system, and/or access recommendations for operation and service of the HVAC unit 104.

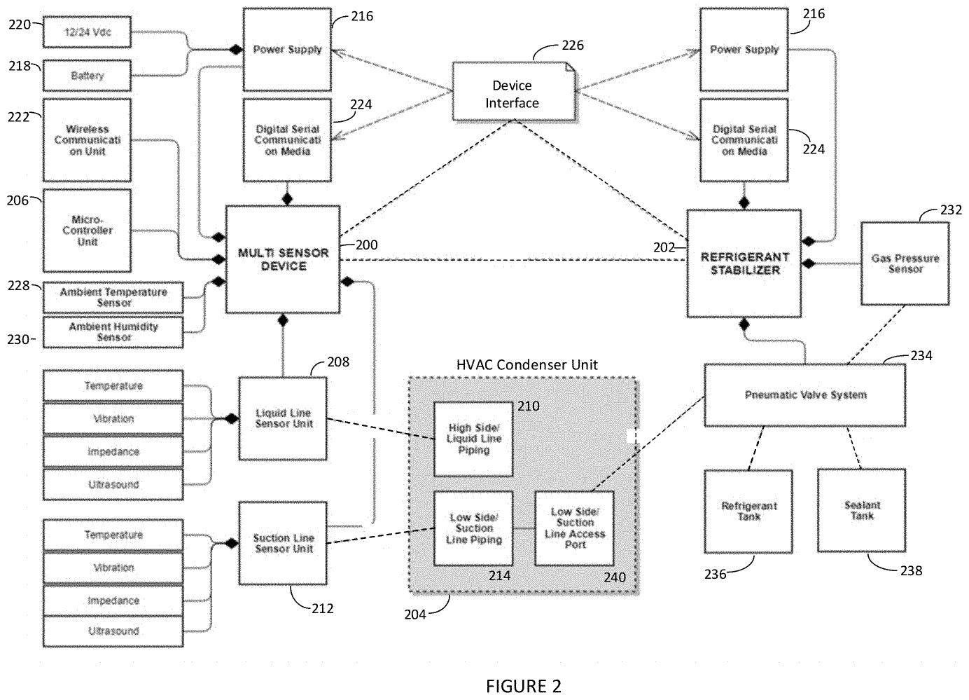

Turning now to FIG. 2, this figure presents a system configuration for the Pressure Monitoring and Stabilization (PMS) system that consists of two main units, the Multi Sensor Device 200 and the Refrigerant Stabilizer device 202. The Multi Sensor Device 200 can be used as a standalone product to monitor the condition of outdoor condenser unit 204 and report it to a cloud-based measurement data storage and analysis system 106, such as, in a non-limiting example the Breezi-Cloud, if equipped with the Refrigerant Stabilizer device 202, the compound system can also recharge refrigerant, to the HVAC system condenser unit 204 to which it is mounted and connected. The PMS system can also add sealant compound to the refrigerant system of the HVAC system as necessary, either on an as needed basis or on a demand or scheduled basis. Both refrigerant recharge and sealant injection are conducted by Refrigerant Stabilizer device under the control of the Micro-Controller component 206 of the Multi Sensor Device 200. Refrigerant recharge and sealant injection can be done automatically by the PMS System or through a directed command from a remote human operator.

In an embodiment, the Multi Sensor device 200 is in electrical and data communication with a liquid line sensor unit 208. The liquid line sensor unit 208 is mounted on the high side/liquid line piping 210 of the HVAC condenser unit 204. The sensors forming the liquid line sensor unit 208 are active to collect temperature, vibration, impedance, and ultrasound measurements and transmit them from the liquid line sensor unit 208 to the Multi Sensor device 200. The Multi Sensor device 200 is also in electrical and data communication with the suction line sensor unit 212. In operation the suction line sensor unit 212 is mounted on the low side/suction line piping 214 of the HVAC condenser unit 204. The sensors forming the suction line sensor unit 212 are active to collect temperature, vibration, impedance, and ultrasound measurements and transmit them from the suction line sensor unit 212 to the Multi Sensor device 200.

In an embodiment, the Multi Sensor device 200 is powered by a Power Supply 216 which may deliver 12/24-volt Direct Current (DC) power to the Multi Sensor device 200 either from an integrated battery 218 or from a line connection through a transformer that delivers 12/24 Volts DC 220. The Multi Sensor device 200 may communicate either through a wireless communications unit 222, a digital serial communication media capability 224, or through both communications pathways. Command and control instructions, as well as collected sensor data may be transmitted from the Multi Sensor device 200 and the Refrigerant Stabilizer 202 through a device interface component 226 that may transfer information from the Multi Sensor device 200 and the Refrigerant Stabilizer 202 to the Breezi-Cloud and/or other outside cloud-based data and storage system (not shown).

In an embodiment, the Multi Sensor device 200 may also be in electrical and data communication with an ambient temperature sensor 228 and an ambient humidity sensor 230. The ambient sensors provide a baseline from ambient conditions to provide the PMS system with an analytical point of reference when analyzing incoming data and measurements from the Multi Sensor device 200.

In an embodiment, the Refrigerant Stabilizer device 202, if connected to the PMS system and in data communication with the Multi Sensor device 200, may also be powered by the Power Supply 216 and may deliver command, control, and sensor data through the digital serial communication media capability 224. Additionally, the Refrigerant Stabilizer device 202 may be in electrical and data connection with a gas pressure sensor 232. The gas pressure sensor 232 providing ongoing measurements of the gas pressure levels within the HVAC condenser unit 204.

In an embodiment, the Refrigerant Stabilizer device 202 is in electrical and data communication with a pneumatic valve system 234. The pneumatic valve system 234 is in electrical and data connection with a refrigerant tank 236 and a sealant tank 238. The pneumatic valve system is physically connected to the low side/suction line access port 240 of the HVAC condenser unit 204. In this embodiment, if the PMS determines that the HVAC condenser unit 204 refrigerant level or system pressure are below the operational settings for these parameters, the Refrigerant Stabilizer device 202 may transmit commands to either the sealant tank 238 to inject a sealant into the HVAC condenser unit 204 to seal leaks in the system and/or the refrigerant tank to inject additional refrigerant into the HVAC condenser unit 204 to bring the pressure and refrigerant level measurements back into operational range as specified either by the manufacturer of the HVAC system or into an operational range as specified by a user/owner of the HVAC system.

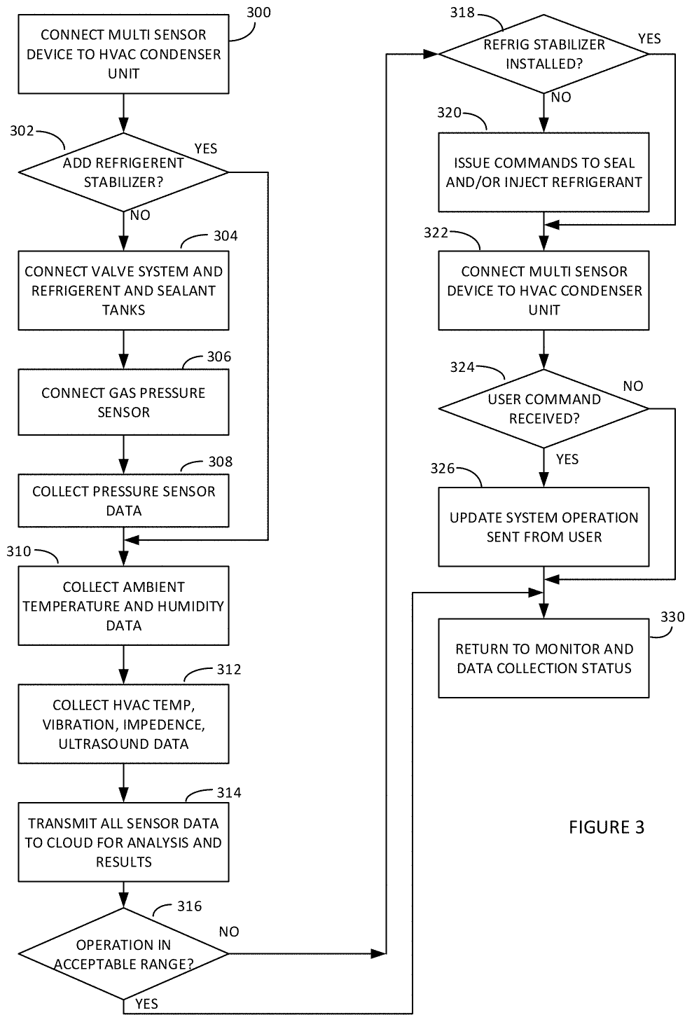

Turning now to FIG. 3, this figure presents a flow diagram of an exemplary method of monitoring an HVAC pressure monitoring system. The monitoring process begins at 300 by connecting the Multi Sensor device of the PMS to the condenser unit of an HVAC system, where the HVAC system may be a commercial unit, a unit installed within a residential space, or other HVAC system installation. The installation of the Multi Sensor device includes connections to the Power supply, the wireless and digital serial communications units, connecting the liquid line unit to a high side/liquid line piping, connecting the suction line sensor unit to the low side/suction line piping, and connecting the ambient temperature and humidity sensors. The micro-controller unit within the Multi Sensor device is now active to begin monitoring and collecting sensor data from the temperature, vibration, impedance, and ultrasound sensors connected to the Multi Sensor device. At 302, the installed Multi Sensor device may inquire of the installer if a Refrigerant Stabilizer device is to be installed as well. If the Refrigerant Stabilizer device is to be installed, at 304 the installer or user may connect the pneumatic valve system to the low side/suction line access port and connect the refrigerant and sealant tanks to the pneumatic valve system. The Refrigerant Stabilizer is also connected to the power supply and digital serial communications unit, and the gas pressure sensor at 306. The Refrigerant Stabilizer device may now begin to monitor and collect gas sensor measurements and data at 308.

At 310, the Multi Sensor device monitors and collects ambient temperature and humidity sensor data in real-time. The Multi Sensor device is also active to monitor and collect temperature, vibration, impedance, and ultrasound sensor data and measurements in real-time at 312. The Multi Sensor device at 314 is active to transmit all collected sensor data and measurements to the cloud system, such as, in a non-limiting example, to the Breezi-Cloud data and storage system, for storage and analysis.

In an embodiment, at 316 the PMS compares the analysis of the real-time operation of the HVAC system against pre-configured performance and operation parameters developed by a manufacturer that indicate optimum performance for the HVAC system, or against user/owner specified performance and operation parameters. If the performance and operation of the HVAC system is above or below the optimum or expected performance range, at 318 the PMS may check to determine if the Refrigerant Stabilizer has been installed. If the Refrigerant Stabilizer has been installed, at 320 the PMS may issue command data to the Refrigerant Stabilizer to inject sealant, additional refrigerant, or both into the HVAC system in an attempt to re-establish optimum or expected operational levels for the monitored sensor measurement data.

In an embodiment, at 322 the Multi Sensor device may format alerts and reports and transmit these alerts and reports to the user/owner/service provider that is responsible for the continued operation of the HVAC unit. At 324 the Multi Sensor device may check to determine if user/owner/service provider commands have been received from the PMS. If such commands have been received, at 326 the Multi Sensor device may implement the commands transmitted from the user/owner/service provider to place the HVAC system within the operational performance limits preferred, based upon the sensor data and measurement levels collected from the sensors connected to the Multi Sensor and/or Refrigerant Stabilizer devices.

At 330, if all collected sensor measurements are within pre-configured manufacturer limits and/or limits input by the user/owner/service provider, the Multi Sensor device returns to monitor and data collection actions.

While certain illustrative embodiments have been described, it is evident that many alternatives, modifications, permutations and variations will become apparent to those skilled in the art in light of the foregoing description.

We claim:

1. A system for pressure monitoring and stabilization in a Heating, Ventilating, and Air Conditioning (HVAC) system, comprising:
a pressure stabilizer device further comprised of at least a multisensor device;
said multisensor device in physical connection with the condenser unit of said HVAC system;
said pressure stabilizer device in data communication with a cloud-based data storage and management system;
the multisensory device comprising a plurality of sensors, where said plurality of sensors collect at least temperature, vibration, impedance, and ultrasound data associated with said HVAC system;
the multisensory device transmitting said collected sensor data to the cloud-based data storage and management system;
the cloud-based data storage and management system active to analyze the transmitted collected sensor data to compare against pre-established operational performance limits for said HVAC system;
the cloud-based data storage and management system formatting and transmitting alerts and reports to the pressure stabilizer device and to one or more users.

2. The system of claim 1, further comprising:
the multisensor device having a liquid line sensor component and a suction line sensor component, where the liquid line sensor component and the suction line sensor component are physically connected to the condenser unit of said HVAC system.

3. The system of claim 1, further comprising an ambient temperature sensor and an ambient humidity sensor in data communication with said multisensor device.

4. The system of claim 1, where the pressure stabilizer device further comprises a refrigerant stabilizer device.

5. The system of claim 4, where the refrigerant stabilizer device further comprises a gas pressure sensor.

6. The system of claim 4, where the refrigerant stabilizer device further comprises a pneumatic valve system that is physically connected to the condenser unit of said HVAC system.

7. The system of claim 6, where the pneumatic valve system further comprises at least a refrigerant tank and a sealant tank.

8. The system of claim 1, where the sensor data collected and transmitted to said cloud-based data storage and management system comprises at least HVAC temperature, vibration, impedance, and ultrasound data and ambient temperature and ambient humidity data.

9. The system of claim 1, where the pressure stabilizer device further comprises a device interface component to connect and manage power and data communication among said multisensor device and the refrigerant stabilizer device.

10. The system of claim 1, where the formatting and transmitting of alerts and reports further comprises the analysis of the real-time operation of the HVAC system against pre-configured performance and operation parameters developed by a manufacturer that indicate optimum performance for the HVAC system, and/or against user/owner specified performance and operation parameters.
